(19) United States
(12) Patent Application Publication
(10) Pub. No.: US 2023/0294711 A1
(43) Pub. Date: Sep. 21, 2023

(54) ROAD WALL SHAPE ESTIMATION DEVICE AND ROAD WALL SHAPE ESTIMATION METHOD

(71) Applicant: Mitsubishi Electric Corporation, Tokyo (JP)

(72) Inventors: Koji IIDA, Tokyo (JP); Tomohiro AKIYAMA, Tokyo (JP)

(73) Assignee: Mitsubishi Electric Corporation, Tokyo (JP)

(21) Appl. No.: 18/017,569

(22) PCT Filed: Oct. 28, 2020
(86) PCT No.: PCT/JP2020/040364

§ 371 Date: Jan. 23, 2023

(51) Int. Cl. B60W 40/105

(52) U.S. Cl. CPC B60W 40/105; B60W 2552/20

(57) ABSTRACT

Provided is a road wall shape estimation device for estimating the shape of a road wall at a long distance from a vehicle, with high accuracy. This road wall shape estimation device includes: a filter processing unit which sets a plurality of filters, and among observation points acquired by an observation data acquisition unit, outputs only observation points whose relative-to-ground velocities are equal to or smaller than a predetermined value and whose positions are inside the filters; a reference point calculation unit which calculates reference points from the output of the filter processing unit; and a road wall estimation unit which estimates the shape of the road wall from the reference points. The filter processing unit increases the width of each filter as the position of the filter becomes farther from an own vehicle.

### TECHNICAL FIELD

The present disclosure relates to a road wall shape estimation device and a road wall shape estimation method.

### BACKGROUND ART

As an estimation device for estimating the shape of a road or a road wall from an observation data group obtained by sensing device mounted to a vehicle traveling on the road, an estimation device using a filter is proposed. For example, using information of observation points present in a filter having a predetermined size, observation points on right and left road walls are selected, and using information of observation points in the filter, the position and the advancement direction of the filter are sequentially determined, to move the filter. The road width is estimated from information of the selected observation points, and the shape of the road or the road wall is estimated from the advancement direction of the filter and the road width (see, for example, Patent Document 1).

### CITATION LIST

### Patent Document

Patent Document 1: Japanese Patent No. 6345138

### SUMMARY OF THE INVENTION

### Problems to Be Solved by the Invention

Regarding the sensing device, accuracy of observation for a point at a long distance might be lower than accuracy of observation for a near point. Further, an object other than an observation target might be erroneously detected or an observation target might be failed to be detected. Thus, the conventional road wall shape estimation device has a problem that, in a case of estimating the shape of a far road wall at a long distance from a vehicle, accuracy of estimation is reduced or the road wall shape cannot be estimated.

The present disclosure has been made to solve the above problem, and an object of the present disclosure is to provide a road wall shape estimation device capable of estimating the shape of a road wall at a long distance from a vehicle, with high accuracy.

### Solution to the Problems

A road wall shape estimation device according to the present disclosure is for estimating a shape of a road wall from information of an observation point cloud acquired by surrounding environment sensing device provided to an own vehicle, the road wall shape estimation device including: an own-vehicle motion data acquisition unit which acquires motion information including a velocity of the own vehicle from own-vehicle motion sensing device; an observation data acquisition unit which acquires the information of the observation point cloud from the surrounding environment sensing device; a filter processing unit which sets, in a virtual space where the observation point cloud is distributed, a plurality of rectangular filters in which a frontward direction of the own vehicle or an extending direction of a road wall candidate is a depth direction of each filter and a direction perpendicular to the depth direction is a width direction of each filter, such that the filters are arranged in the frontward direction of the own vehicle, and from the observation point cloud acquired by the observation data acquisition unit, outputs only observation points whose relative-to-ground velocities are equal to or smaller than a predetermined value and whose positions are inside the filters; a reference point calculation unit which calculates a reference point in each filter from the output of the filter processing unit; and a road wall estimation unit which estimates the shape of the road wall from the reference points. The filter processing unit increases a width of each filter as a position of the filter becomes farther from the own vehicle.

### EFFECT OF THE INVENTION

The road wall shape estimation device according to the present disclosure includes: the own-vehicle motion data acquisition unit which acquires motion information including the velocity of the own vehicle from the own-vehicle motion sensing device; the observation data acquisition unit which acquires the information of the observation point cloud from the surrounding environment sensing device; the filter processing unit which sets, in the virtual space where the observation point cloud is distributed, the plurality of rectangular filters in which the frontward direction of the own vehicle or the extending direction of the road wall candidate is the depth direction of each filter and the direction perpendicular to the depth direction is the width direction of each filter, such that the filters are arranged in the frontward direction of the own vehicle, and from the observation point cloud acquired by the observation data acquisition unit, outputs only observation points whose relative-to-ground velocities are equal to or smaller than the predetermined value and whose positions are inside the filters; the reference point calculation unit which calculates the reference point in each filter from the output of the filter processing unit; and the road wall estimation unit which estimates the shape of the road wall from the reference points. The filter processing unit increases the width of each filter as the position of the filter becomes farther from the own vehicle. Thus, the shape of a road wall at a long distance from the vehicle can be estimated with high accuracy.

### BRIEF DESCRIPTION OF THE DRAWINGS

FIG. 1 is a block diagram showing the configuration of a road wall shape estimation device according to embodiment 1.

FIG. 2 shows an example of an output of surrounding environment sensing device in embodiment 1.

FIG. 3 is a flowchart illustrating operation of the road wall shape estimation device according to embodiment 1.

FIG. 4 illustrates a first filter setting method in embodiment 1.

FIG. 5 illustrates a second filter setting method in embodiment 1.

FIG. 6 illustrates a third filter setting method in embodiment 1.

FIG. 7 illustrates a fourth filter setting method in embodiment 1.

FIG. 8 is a block diagram showing the configuration of a road wall shape estimation device according to embodiment 2.

FIG. 9 is a flowchart illustrating operation of the road wall shape estimation device according to embodiment 2.

FIG. 10 illustrates operation of a reference point calculation unit in embodiment 2.

FIG. 11 is a block diagram showing the configuration of a road wall shape estimation device according to embodiment 3.

FIG. 12 is a flowchart illustrating operation of the road wall shape estimation device according to embodiment 3.

FIG. 13 shows observation points acquired at respective times in the road wall shape estimation device according to embodiment 3.

FIG. 14 shows observation points used for road wall estimation in the road wall shape estimation device according to embodiment 3.

FIG. 15 is a block diagram showing the configuration of a road wall shape estimation device according to embodiment 4.

FIG. 16 is a flowchart illustrating operation of the road wall shape estimation device according to embodiment 4.

FIG. 17 illustrates operation of a reference point calculation unit in embodiment 4.

FIG. 18 shows the hardware configuration of the road wall shape estimation device according to each of embodiments 1 to 4.

### DESCRIPTION OF EMBODIMENTS

Hereinafter, a road wall shape estimation device according to embodiments for carrying out the present disclosure will be described in detail with reference to the drawings. In the drawings, the same reference characters denote the same or corresponding parts.

### Embodiment 1

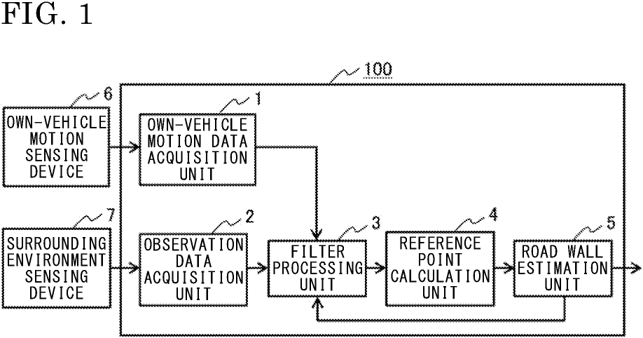

FIG. 1 is a block diagram showing the configuration of a road wall shape estimation device 100 according to embodiment 1. As shown in FIG. 1, the road wall shape estimation device 100 includes an own-vehicle motion data acquisition unit 1, an observation data acquisition unit 2, a filter processing unit 3, a reference point calculation unit 4, and a road wall estimation unit 5. Own-vehicle motion sensing device 6 is a sensor for acquiring motion information such as the velocity, the yaw rate, and the acceleration of the own vehicle. The own-vehicle motion data acquisition unit 1 acquires motion information of the own vehicle from the own-vehicle motion sensing device 6.

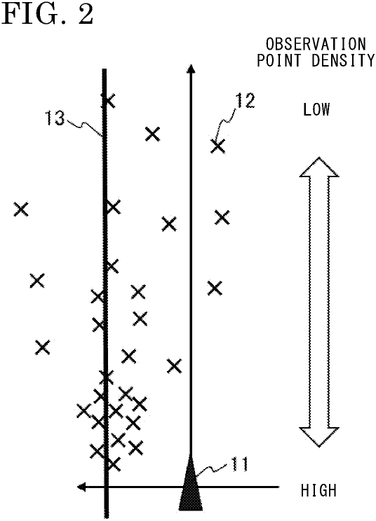

Surrounding environment sensing device 7 is a sensor such as a laser, a radar, or a camera, which is provided to the own vehicle and acquires environment information around the own vehicle. The observation data acquisition unit 2 acquires information of an observation point cloud including position information and velocity information of objects such as another vehicle, a road wall, a pedestrian, and a road structure present around the own vehicle, from the surrounding environment sensing device 7. FIG. 2 shows an example of an output of the surrounding environment sensing device 7, and shows a virtual space where the observation point cloud is distributed. FIG. 2 shows position information of observation points 12 in a case of acquiring position information of a road wall 13 present at the left of an own vehicle 11. For example, in a case where sensing device such as a millimeter-wave radar is used as the surrounding environment sensing device 7, the density of the observation points 12 is high near the own vehicle 11 where the sensor is provided, and the density of the observation points 12 is low at a long distance from the own vehicle 11. Therefore, at a location distant from the own vehicle 11, error of an observation result is great.

In the filter processing unit 3, from information of the observation point cloud which is the surrounding environment information acquired by the observation data acquisition unit 2, observation points observed from a static object are extracted using velocity information of the own vehicle and velocity information of observation points, a plurality of rectangular filters are set in the virtual space, and only observation points present inside the filters are extracted, whereby observation points to be used for road wall estimation are selected. The reference point calculation unit 4 calculates a reference point in each filter from the observation points selected by the filter processing unit 3. The road wall estimation unit 5 estimates the road wall shape from information of the reference points calculated by the reference point calculation unit 4, and outputs an estimation result.

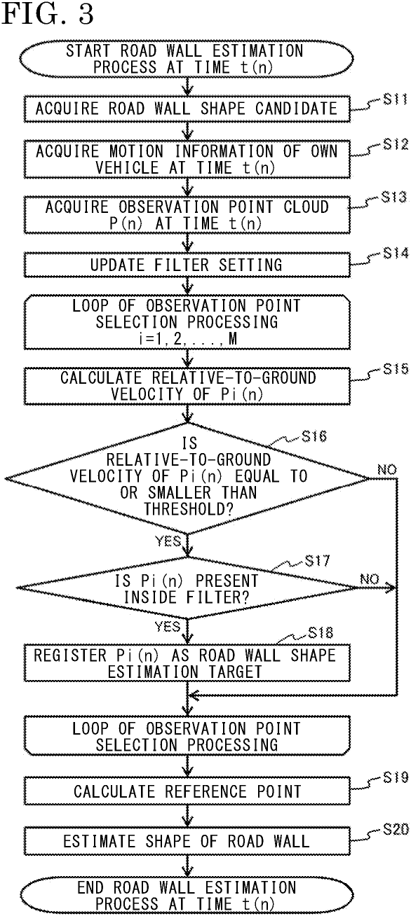

Next, operation of the road wall shape estimation device 100 will be described with reference to a flowchart. FIG. 3 is a flowchart illustrating a process executed by the road wall shape estimation device 100 at an observation time t(n), and this process is repeatedly executed at constant time intervals, e.g., an observation update cycle of the surrounding environment sensing device 7. As used herein, the observation time t(n) is defined as present, and an observation time that is one cycle before the observation time t(n) is defined as t(n-1). Step S11 is a road wall candidate acquisition step, step S12 is an own-vehicle motion data acquisition step, step S13 is an observation data acquisition step, and step S14 is a filter update step. Steps S15 to S18 are filter processing steps. Step S19 is a reference point calculation step, and a step S20 is a road wall estimation step.

### 1-1. Acquisition of Road Wall Candidate

In step S11, the filter processing unit 3 acquires information of a road wall candidate which is a candidate for a road wall shape. The information of the road wall candidate acquired in step S11 may be the shape of the road itself or the shape of a road wall present at the left or right along the road. The information of the road wall candidate to be acquired is either of the following information.
A: Information of a road wall shape estimated at a past observation time
B: Information of a road shape or a road wall shape acquired from outside

In the case of “A”, on the basis of the fact that the road wall shape does not change over time, information of a road wall shape estimated at a past observation time is used as a road wall candidate. In a case where there is no information of a road wall shape estimated at a past observation time, e.g., a case where a road wall shape is to be initially estimated or a case where a road wall shape could not be estimated at a past observation time, it is assumed that a road wall candidate has a straight shape with respect to the frontward direction of the own vehicle 11, and it is assumed that a straight road wall with respect to the frontward direction of the own vehicle 11 is present at a position away from the own vehicle 11 in a lateral direction by a predetermined distance, whereby a road wall candidate is set. In a case of “B”, for example, a detection result for a marking line from a frontward monitoring camera which is second surrounding environment sensing device is used as a road wall candidate. Alternatively, a road shape at the position of the own vehicle 11 is acquired on the basis of the latitude, the longitude, and the azimuth of the own vehicle 11 and map information, and the road shape is used as information of a road wall candidate. Next, the process proceeds to step S12.

### 1-2. Acquisition of Motion Information of Own vehicle

In step S12, the own-vehicle motion data acquisition unit 1 acquires motion information of the own vehicle 11 at the observation time t(n) from the own-vehicle motion sensing device 6, and outputs the motion information to the filter processing unit 3. The motion information of the own vehicle 11 includes the velocity and the yaw rate of the own vehicle 11. Next, the process proceeds to step S13.

### 1-3. Acquisition of Observation Point Cloud

In step S13, the observation data acquisition unit 2 acquires information of an observation point cloud P(n) at the observation time t(n) from the surrounding environment sensing device 7, and outputs the information to the filter processing unit 3. The information of the observation point cloud P(n) includes position information and velocity information of each observation point 12. Next, the process proceeds to step S14.

### 1-4. Update of Filter Setting

In step S14, the filter processing unit 3 updates setting of a filter. The filter is used for extracting observation points 12 to be used for estimation of a road wall shape, from the observation point cloud obtained at the observation time t(n). The filter has a rectangular shape in which a frontward direction of the own vehicle 11 or an extending direction of the road wall candidate is a depth direction and a direction perpendicular to the depth direction is a width direction, in the virtual space where the observation point cloud is distributed. In the virtual space, a plurality of filters are set so as to be arranged in the frontward direction of the own vehicle 11. For the filter setting, any of a “first filter setting method” to a “fourth filter setting method” described below is used. After the filter setting is updated, the process proceeds to step S15.

### <First Filter Setting Method>

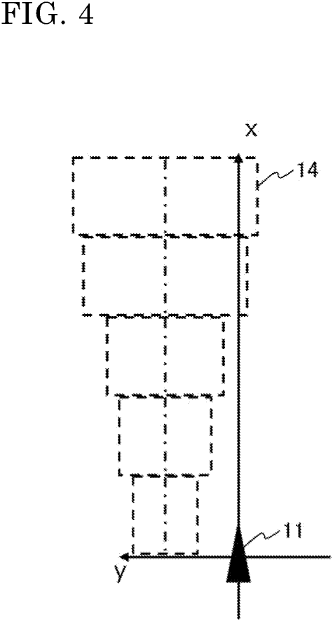

FIG. 4 illustrates the first filter setting method in the virtual space. In FIG. 4, an axis in the frontward direction of the own vehicle 11 is defined as x axis, an axis in the lateral direction of the own vehicle 11 perpendicular to the x axis is defined as y axis, and filters 14 for estimating the shape of a road wall present at the left of the own vehicle 11 are shown by dotted-line rectangles. In the first filter setting method, it is assumed that the extending direction of the road wall in the virtual space extends straightly in the frontward direction of the own vehicle 11. The frontward direction of the own vehicle 11 is the depth direction of the filters 14, and the direction perpendicular to the depth direction, i.e., the lateral direction of the own vehicle 11 is the width direction of the filters 14. The center positions in the width direction of the respective filters 14 are aligned straightly in the frontward direction of the own vehicle 11. The filters 14 are arranged adjacently to each other in the frontward direction of the own vehicle 11. The filter 14 closest to the own vehicle 11 is defined as a first filter, and the filter 14 farthest from the own vehicle 11 is defined as Nth filter. The depth-direction length of an fth filter 14 (f = 1, 2, ..., N) is denoted by h_f, and the width-direction length thereof is denoted by w_f. In this case, as the position of each filter 14 becomes farther from the own vehicle 11, i.e., as the value of f increases, w_f which is the width of the filter 14 increases. As shown in FIG. 2, the density of data of the observation points 12 which are the output of the surrounding environment sensing device 7 becomes lower as the position becomes farther from the own vehicle 11. By increasing w_f which is the width of each filter 14 as the position of the filter 14 becomes farther from the own vehicle 11, it becomes possible to use data of more observation points 12 even in the filter 14 at a position far from the own vehicle 11, and thus reduction of accuracy of estimation for a road wall shape at a position far from the own vehicle 11 can be suppressed. In FIG. 4, the filters 14 are set only at the left of the own vehicle 11. However, in a case of estimating the shape of a road wall at the right of the own vehicle 11, the filters 14 are set at the right of the own vehicle 11, and in a case of estimating the shapes of road walls at both of the right and the left of the own vehicle 11, the filters 14 are set at both of the right and the left of the own vehicle 11. Such a configuration that the filters 14 may be set at the right of the own vehicle 11 or at both of the right and the left of the own vehicle 11 applies also in second to fourth filter setting methods described below.

### <Second Filter Setting Method>

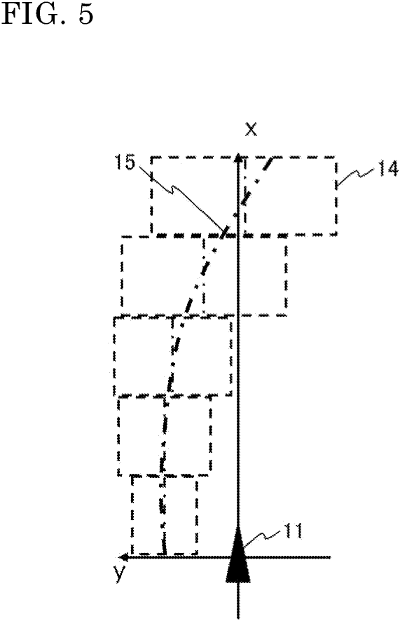

FIG. 5 illustrates the second filter setting method in the virtual space. In the second filter setting method, using the information of the road wall candidate acquired in step S11, the positions in the y-axis direction of the filters 14 are moved. The frontward direction of the own vehicle 11 is the depth direction of the filters 14, and the setting method for h_f and w_f which are the lengths of sides of the rectangle of each filter 14, and the positions in the x-axis direction of the filters 14, are the same as in the first filter setting method. Regarding the positions in the y-axis direction of the filters 14, the positions in the y-axis direction of the center points of the rectangles of the filters 14 are set along the road wall candidate 15 acquired in step S11. In FIG. 5, the positions in the y-axis direction of the center points of the rectangles of the filters 14 are set to coincide with the road wall candidate 15 acquired in step S11. The length h_f which is the depth-direction length of the rectangle of each filter 14 may be changed in accordance with reliability of the information of the road wall candidate acquired in step S11, whereby the size of the filter 14 may be enlarged. For example, if reliability of the information of the road wall candidate is lower than a predetermined value, h_f may be increased by a certain ratio, to enlarge the size of the filter 14. By moving the positions in the y-axis direction of the filters 14 using the information of the road wall candidate as described above, observation points considered to have been observed from the road wall can be selected, whereby the road wall shape can be estimated with high accuracy.

### <Third Filter Setting Method>

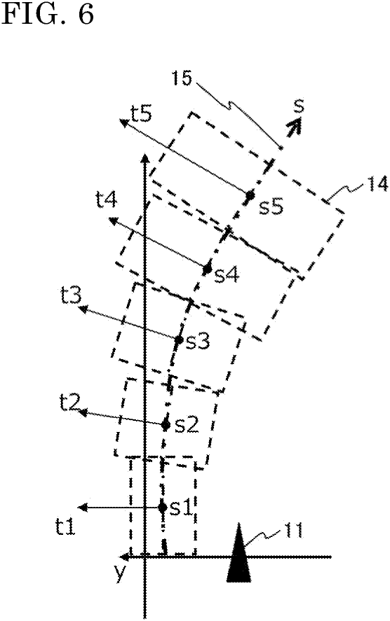

FIG. 6 illustrates the third filter setting method in the virtual space. In the third filter setting method, using the information of the road wall candidate acquired in step S11, the positions of the filters 14 are moved and the rectangles of the filters 14 are rotated. The extending direction of the road wall candidate acquired in step S11 is defined as s axis, the center position of the first filter is denoted by s1 on the s axis, and the center position of the fth filter is denoted by sf on the s axis. The filters 14 are set at such intervals that h_f which is the depth-direction length of the filter 14 and the curve length of the s axis coincide with each other. An axis perpendicular to the s axis at the point sf is defined as tf axis. A side in the width direction of the filter 14 having the center position at the point sf is set to be parallel to the tf axis. That is, for each filter, the extending direction of the road wall candidate is the depth direction, and the direction perpendicular to the extending direction is the width direction. As in the first filter setting method, the width-direction length w f of each filter 14 is increased as the position of the filter 14 becomes farther from the own vehicle 11. As in the second filter setting method, the length h_f which is the depth-direction length of the filter 14 may be changed in accordance with reliability of the information of the road wall candidate acquired in step S11. By moving the positions in the y-axis direction of the filters 14 and rotating the rectangles thereof using the information of the road wall candidate as described above, it is possible to, even if the curvature of the road is great, select observation points considered to have been observed from the road wall and cope with variations of data in the road width direction, whereby the road wall shape can be estimated with high accuracy.

### <Fourth Filter Setting Method>

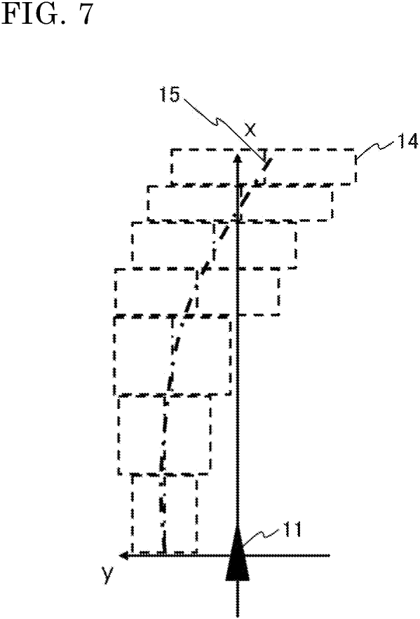

FIG. 7 illustrates the fourth filter setting method in the virtual space. In the fourth filter setting method, in addition to using the “second filter setting method” or the “third filter setting method”, as the curvature of the road of the road wall candidate acquired in step S11 increases, i.e., as the curve becomes sharper, h_f which is the depth-direction length of each filter 14 is decreased. FIG. 7 shows an example in which h f of each filter 14 is decreased as the curvature of the road increases, in addition to using the second filter setting method. In the fourth filter setting method, the filters 14 are more finely divided at positions where the curvature is greater. Thus, the filters 14 can be set in a shape closer to the shape of the road.

Steps S15 to S18 are loop processing of observation point selection processing, and are executed in the filter processing unit 3. In a case where there are M observation points 12 included in the observation point cloud P(n) acquired at the observation time t(n), each observation point 12 is denoted by Pi(n), and i takes a value of 1 to M. The loop of the observation point selection processing from step S15 to step S18 is executed for each Pi(n), and thus is executed M times in total.

### 1-5. Calculation of Relative-to-ground Velocity

In step S15, a relative-to-ground velocity of the observation point Pi(n), i.e., the velocity of the observation point Pi(n) relative to the ground is calculated. The information of the observation point cloud P(n) acquired in step S13 includes position information and velocity information of each observation point Pi(n), and the position information and the velocity information are information in a coordinate system based on the own vehicle 11 to which the surrounding environment sensing device 7 is mounted. Therefore, the velocity information of the observation point Pi(n) is a relative velocity with respect to the velocity of the own vehicle 11. The velocity of the own vehicle 11 is denoted by Vego, and of the velocity of the observation point Pi(n), a velocity component in the advancement direction of the own vehicle 11 is denoted by Vx. A relative-to-ground velocity Vground of the observation point Pi(n) is calculated by the following Expression (1), and then the process proceeds to step S16.

$$\text{Vground} = \text{Vx} - \text{Vego} \qquad \text{(1)}$$

### 1-6. Determination for Relative-to-Ground Velocity

In step S16, whether or not the observation point Pi(n) is a static object is determined from the relative-to-ground velocity Vground of the observation point Pi(n) calculated in step S15. If Vground is equal to or smaller than a predetermined threshold Vthresh_static, the observation point Pi(n) is determined to be a static object, and then the process proceeds to step S17. If Vground is greater than the predetermined threshold Vthresh_static, the observation point Pi(n) is determined to be a moving object, and the observation point selection processing for the observation point Pi(n) is finished, thus shifting to the processing for the next observation point.

### 1-7. Determination for Data in Filter

In step S17, whether or not the observation point Pi(n) is present inside the filter 14 set in step S14 is determined. If the observation point Pi(n) is present inside the filter 14, the process proceeds to step S18. If the observation point Pi(n) is present outside the filter 14, the observation point selection processing for the observation point Pi(n) is finished, thus shifting to the processing for the next observation point.

### 1-8. Registration as Road Wall Shape Estimation Target

In step S18, since the observation point Pi(n) is determined to be an observation point that is a road wall shape estimation target, the observation point Pi(n) is registered as a road wall shape estimation target, and information of the observation point Pi(n) is outputted to the reference point calculation unit. The observation point selection processing for the observation point Pi(n) is finished, thus shifting to the processing for the next observation point.

If the observation point selection processing is finished for all the observation points Pi(n), the process proceeds to step S19.

### 1-9. Calculation of Road Wall Reference Point

In step S19, the reference point calculation unit 4 calculates a reference point in each filter 14 from the observation points registered as road wall shape estimation targets in step S18. The position of the reference point is any of an average position of the positions of observation points present inside each filter 14 which are estimation target observation points, the position of the observation point closest to the own vehicle 11 among observation points present inside each filter 14, or the most frequent position of observation points present inside each filter. Next, the process proceeds to step S20.

### 1-10. Estimation for Road Wall Shape

In step S20, the road wall estimation unit 5 estimates the road wall shape from the reference points calculated in step S19. Estimation for the road wall shape is performed as follows. The reference points are connected or the reference points are applied to a predetermined curve, and then a line of an end portion of the road wall is calculated, whereby the shape of the road wall is estimated. Information of the road wall shape estimated by the road wall estimation unit 5 is outputted, and thus the process by the road wall shape estimation device 100 at the observation time t(n) is ended.

As described above, the road wall shape estimation device 100 is for estimating the shape of a road wall from information of an observation point cloud acquired by the surrounding environment sensing device 7 provided to an own vehicle, the road wall shape estimation device 100 including: the own-vehicle motion data acquisition unit 1 which acquires motion information including the velocity of the own vehicle 11 from the own-vehicle motion sensing device 6; the observation data acquisition unit 2 which acquires the information of the observation point cloud from the surrounding environment sensing device 7; the filter processing unit 3 which sets, in the virtual space where the observation point cloud is distributed, a plurality of rectangular filters 14 in which the frontward direction of the own vehicle 11 or the extending direction of a road wall candidate is a depth direction of each filter and a direction perpendicular to the depth direction is a width direction of each filter, such that the filters 14 are arranged in the frontward direction of the own vehicle 11, and from the observation point cloud acquired by the observation data acquisition unit 2, outputs only observation points whose relative-to-ground velocities are equal to or smaller than a predetermined value and whose positions are inside the filters 14; the reference point calculation unit 4 which calculates a reference point in each filter 14 from the output of the filter processing unit 3; and the road wall estimation unit 5 which estimates the shape of the road wall from the reference points. The filter processing unit 3 increases the width of each filter 14 as the position of the filter 14 becomes farther from the own vehicle 11. Thus, the shape of a road wall at a long distance from the vehicle can be estimated with high accuracy.

### Embodiment 2

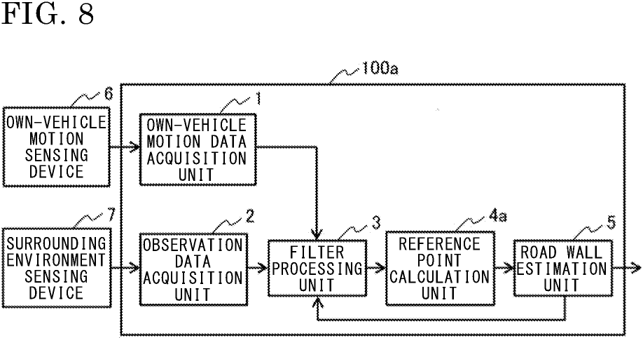

FIG. 8 shows the configuration of a road wall shape estimation device 100a according to embodiment 2. In the road wall shape estimation device 100a according to embodiment 2 shown in FIG. 8, a reference point calculation unit 4a is provided in place of the reference point calculation unit 4 as compared to the road wall shape estimation device 100 according to embodiment 1 shown in FIG. 1. The other configurations of the road wall shape estimation device 100a according to embodiment 2 are the same as those of the road wall shape estimation device 100 according to embodiment 1.

The reference point calculation unit 4a calculates a reference point from observation points selected by the filter processing unit 3, as in the reference point calculation unit 4 of embodiment 1, and at this time, performs clustering processing of making a cluster from the selected observation points on the basis of similarities.

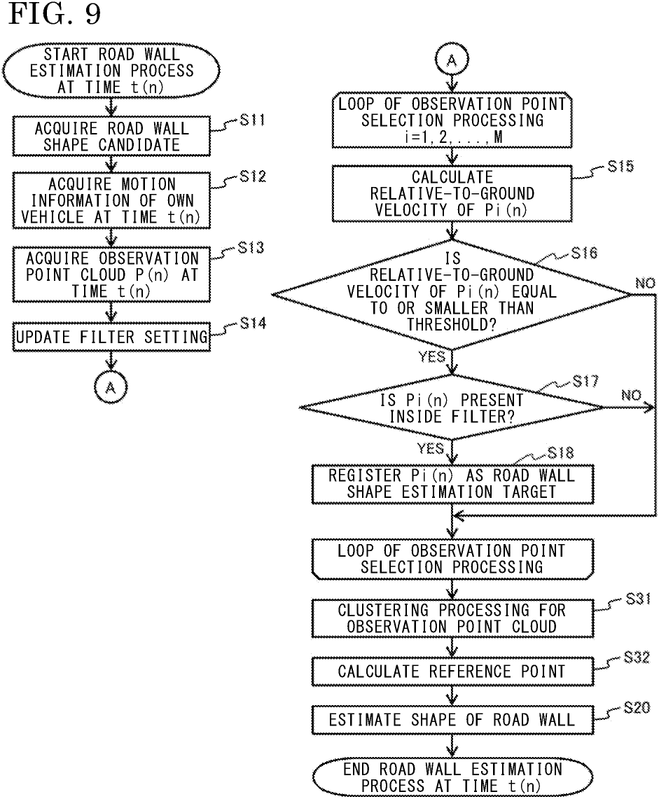

Next, operation of the road wall shape estimation device 100a will be described with reference to a flowchart. FIG. 9 is a flowchart illustrating a process executed by the road wall shape estimation device 100a at an observation time t(n), and this process is repeatedly executed at constant time intervals, e.g., an observation update cycle of the surrounding environment sensing device 7. In FIG. 9, steps S11 to S18 and S20 are the same as those executed by the road wall shape estimation device 100 according to embodiment 1 shown in FIG. 3. In addition, steps S31 and S32 are reference point calculation steps in embodiment 2.

### <Clustering Processing for Observation Points>

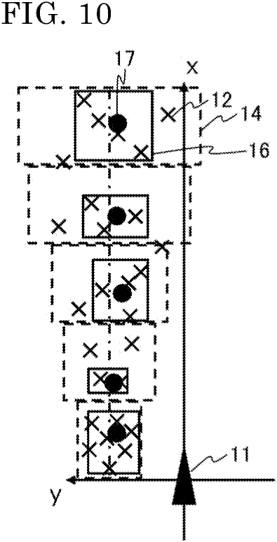

In step S31, the reference point calculation unit 4a performs the clustering processing for the observation points registered as road wall shape estimation targets in step S18. The clustering processing is processing of making a cluster from observation points on the basis of similarities, and may be performed using a known technique. For example, using a DBSCAN algorithm, observation points present in a high-density area where the observation points are densely present so as to be close to each other are extracted as the cluster that is a clustering result, whereas points away from the cluster are excluded as outliers. FIG. 10 illustrates operation of the reference point calculation unit 4a. In FIG. 10, clustering processing for the observation points 12 is performed in each filter 14, whereby a clustering result 16 is obtained. In step S32, using the observation points set as a cluster through the clustering processing in step S31, the position of the reference point is calculated. In FIG. 10, the position of the reference point is calculated from the observation points included in the clustering result 16 obtained through the clustering processing. The position of the reference point is any of an average position of the positions of the observation points set as a cluster which are estimation target observation points, the position of the observation point closest to the own vehicle 11 among the observation points set as a cluster, or the most frequent position of the observation points set as a cluster. In FIG. 10, reference points 17 are shown by black circles.

As described above, the reference point calculation unit 4a performs the clustering processing of making a cluster from observation points which are the output of the filter processing unit 3 on the basis of similarities, and calculates the reference point from a result of the clustering processing. Thus, data of low-reliability observation points away from the cluster can be removed, whereby the road wall shape can be estimated with high accuracy.

### Embodiment 3

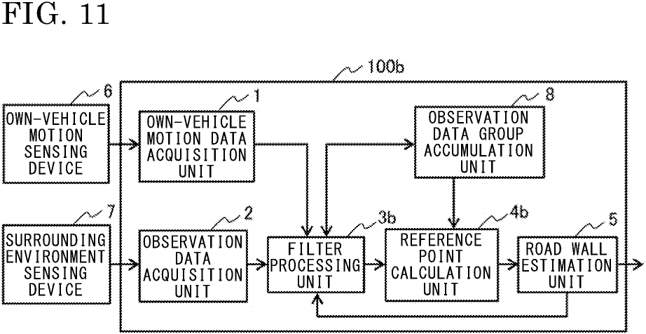

FIG. 11 shows the configuration of a road wall shape estimation device 100b according to embodiment 3. In the road wall shape estimation device 100b according to embodiment 3 shown in FIG. 11, a filter processing unit 3b is provided in place of the filter processing unit 3, and a reference point calculation unit 4b is provided in place of the reference point calculation unit 4, as compared to the road wall shape estimation device 100 according to embodiment 1 shown in FIG. 1. Further, the road wall shape estimation device 100b newly includes an observation data group accumulation unit 8. The other configurations of the road wall shape estimation device 100b according to embodiment 3 are the same as those of the road wall shape estimation device 100 according to embodiment 1.

The filter processing unit 3b selects observation points to be used for road wall estimation by the same method as in the filter processing unit 3 in embodiment 1, outputs information of the selected observation points to the reference point calculation unit 4b, and accumulates the information in the observation data group accumulation unit 8. The reference point calculation unit 4b calculates the reference point from the observation points selected by the filter processing unit 3b and the observation points accumulated in the observation data group accumulation unit 8.

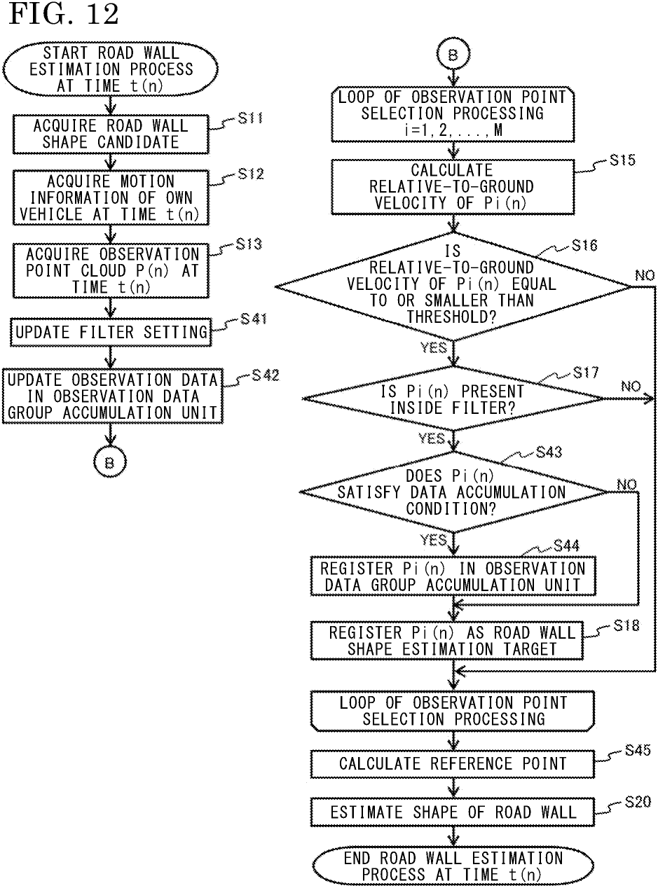

Next, operation of the road wall shape estimation device 100b will be described with reference to a flowchart. FIG. 12 is a flowchart illustrating a process executed by the road wall shape estimation device 100b at an observation time t(n), and this process is repeatedly executed at constant time intervals, e.g., an observation update cycle of the surrounding environment sensing device 7. In FIG. 12, steps S11 to S13, S15 to S17, S18, and S20 are the same as those executed by the road wall shape estimation device 100 according to embodiment 1 shown in FIG. 3. Step S41 is a filter update step in embodiment 3. Step S42 is an accumulated data update step. Steps S43 and S44 are observation point accumulation steps. Step S45 is a reference point calculation step in embodiment 3.

### <Update of Filter Setting>

In step S41, the same processing as in step S14 in embodiment 1 is performed, and a maximum accumulation period t_max of observation point information is set for each of N filters set by any of the first to fourth filter setting methods. The value of t_max is set to be greater as the position of the filter becomes farther from the own vehicle 11. For example, in each filter set by the first filter setting method, t_max is set as t_max = k*p(f). Here, k is a constant and p(f) is the distance from the own vehicle 11 to the fth filter. In a case of making setting so as not to use past observation point information, the value of t_max may be set to zero. For example, if the value of t_max is set to zero for the filter closest to the own vehicle 11, the reference point is determined using only data of observation points acquired by the observation data acquisition unit 2 at the observation time t(n), for the filter closest to the own vehicle 11.

### <Update of Observation Data in Observation Data Group Accumulation Unit>

In the observation data group accumulation unit 8, data of the observation points selected by the filter processing unit 3b in step S43 described in detail later are accumulated. In step S42, the filter processing unit 3b updates data of the observation points accumulated in the observation data group accumulation unit 8. In step S42, the following two processes are performed.
A: Correction for positions of accumulated observation points
B: Deletion of data of observation points that have been stored for a predetermined period or longer

### <A: Correction for Positions of Observation Points>

Where the observation time t(n) is the present and the observation time that is one cycle before the observation time t(n) is denoted by t(n-1), the own vehicle 11 has moved during Δt which is the one cycle period from t(n-1) to t(n). Therefore, the positions of the observation points stored in the observation data group accumulation unit 8 are positions in a coordinate system based on the position of the own vehicle 11 at the observation time t(n-1). Accordingly, the positions of the observation points stored in the observation data group accumulation unit 8 are corrected to positions in a coordinate system based on the position of the own vehicle 11 at the observation time t(n). In the motion information acquired in step S12, the velocity of the own vehicle 11 is denoted by V and the yaw rate of the own vehicle is denoted by ω. In the (x, y) coordinate system shown in FIG. 4, the position in the x-axis direction of the observation point at time t(n-1) is denoted by x(n-1), the position thereof in the y-axis direction is denoted by y(n-1), the position in the x-axis direction of the observation point at time t(n) is denoted by x(n), and the position thereof in the y-axis direction is denoted by y(n). When ω is zero, x(n) and y(n) are calculated by the following expressions.

$$\text{x} \left(\text{n}\right) \text{= x} \left(\text{n} - 1\right) - \text{V*} \text{Δ} \text{t} \qquad \text{(2)}$$

$$\text{y} \left(\text{n}\right) = \text{y} \left(\text{n} - 1\right) \qquad \text{(3)}$$

When ω is not zero, the own vehicle 11 is assumed to perform a uniform circular motion, and x(n) and y(n) are calculated by the following expressions.

$$\text{x} \left(\text{n}\right) = \text{x} \left(\text{n} - 1\right) - \text{V} / \text{ω} * \text{sin} \left(\text{ωΔ} \text{t}\right) \qquad \text{(4)}$$

$$\text{y} \left(\text{n}\right) = \text{y} \left(\text{n} - 1\right) - \text{V} / \text{ω} * \left\{1 - cos \left(\text{ωΔ} \text{t}\right)\right\} \qquad \text{(5)}$$

### <B: Deletion of Data of Observation Points>

For each of the observation points whose positions have been corrected through the processing of “A: Correction for positions of observation points”, whether or not the observation point is present inside any of the filters updated in step S41 is confirmed, and data of the observation point present outside the filters is deleted from the observation data group accumulation unit 8. In addition, for each observation point present inside any of the filters, an accumulation period (t(n)-t_obs) is calculated from time t_obs when the observation point was observed and the present time t(n). Then, whether or not the accumulation period is greater than the maximum accumulation period t_max set for the corresponding filter is confirmed on the basis of whether or not the following Expression (6) is satisfied.

$$\text{t\_max} < \text{t} \left(\text{n}\right) - \text{t\_obs} \qquad \text{(6)}$$

If Expression (6) is satisfied, it is determined that the observation point has been stored for a predetermined period or longer, and thus data of the observation point is deleted from the observation data group accumulation unit 8.

### <Loop of Observation Point Selection Processing>

In the loop of the observation point selection processing in the flowchart shown in FIG. 12, steps S15 to S17 and S18 are the same as those executed by the road wall shape estimation device 100 according to embodiment 1 shown in FIG. 3. In step S43, the filter processing unit 3b determines whether or not the observation point Pi(n) satisfies a data accumulation condition. Through the processing in step S17, the observation point Pi(n) has been found to be present inside any of the filters set in step S41. For each filter, the maximum accumulation period t_max is set, and in the filter for which the value of t_max is positive, there is a possibility that data of a past observation point is used in the process after one cycle. Therefore, it is determined that the observation point present inside the filter for which the value of t_max is positive satisfies the data accumulation condition, and the process proceeds to step S44. On the other hand, it is determined that the observation point present inside the filter for which the value of t_max is zero does not satisfy the data accumulation condition, and the process proceeds to step S18. In step S44, the filter processing unit 3b registers data of the observation point that satisfies the data accumulation condition, in the observation data group accumulation unit 8. It is noted that data of the observation point may be registered in the observation data group accumulation unit 8 in step S44 without performing the processing in step S43. In this case, the observation data group accumulation unit 8 needs to have a larger data storage capacity. However, unnecessary data is deleted in step S42 in the process after one cycle, and therefore an estimation result for the road wall shape does not change.

### <Calculation of Reference Point>

In step S45, the reference point calculation unit 4b receives data of the observation points which are the output of the filter processing unit 3b and acquires data of the observation points from the observation data group accumulation unit 8. Then, using both data, the reference point calculation unit 4b calculates a reference point in each filter. That is, the reference point calculation unit 4b calculates a reference point in each filter, using both of the data of the observation points set as road wall shape estimation targets in step S18 and the data of the observation points observed in the past which have been updated in step S42 and are registered in the observation data group accumulation unit 8. The position of the reference point is any of an average position of the positions of observation points present inside each filter which are estimation target observation points, the position of the observation point closest to the own vehicle 11 among the observation points present inside each filter, or the most frequent position of observation points present inside each filter.

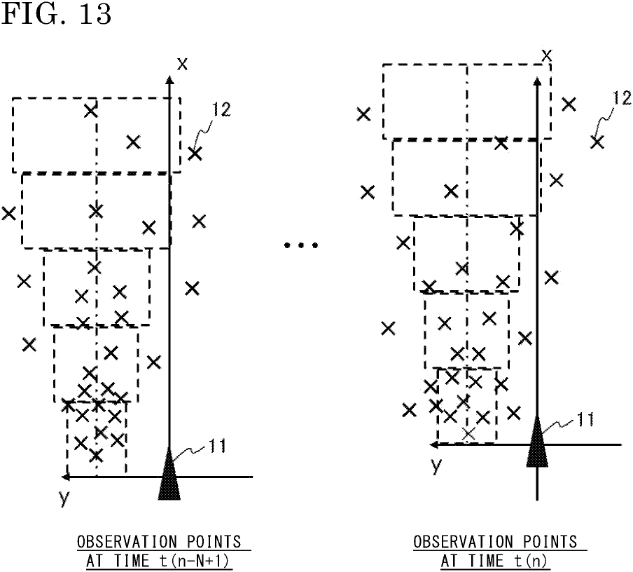

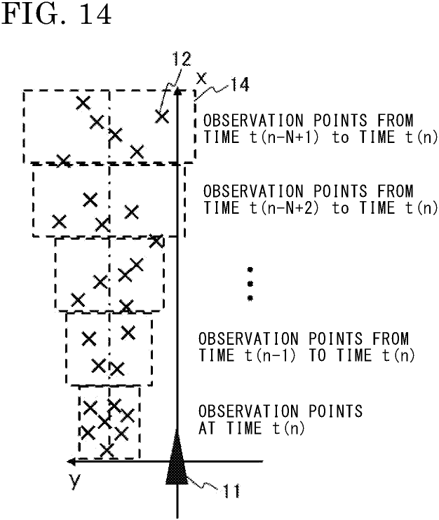

With reference to FIG. 13 and FIG. 14, operation of the road wall shape estimation device 100b according to embodiment 3 will be described. FIG. 13 shows the observation points 12 at time t(n-N+1) and the observation points 12 at time t(n), among the observation points 12 that have been acquired until time t(n) since time t(n-N+1). The observation points have been acquired N times in total until time t(n) since time t(n-N+1). The own vehicle 11 at time t(n) is located frontward of the own vehicle 11 at time t(n-N+1), and along with this, the observation points 12 at time t(n) are located frontward of the observation points 12 at time t(n-N+1). FIG. 14 shows the observation points 12 to be used for road wall shape estimation in step S45 in FIG. 12. The maximum accumulation period t_max of observation point information is set to a greater value as the position of the filter becomes farther from the own vehicle 11. Therefore, in the example shown in FIG. 14, only the observation points at time (n) are included in the filter closest to the own vehicle 11, the observation points at more times are included as the position of the filter 14 becomes farther from the own vehicle 11, and the observation points from time (n-N+1) to time (n) are included in the filter farthest from the own vehicle 11. Therefore, at each observation time, the density of the observation points 12 decreases as the distance from the own vehicle 11 increases, but in the road wall shape estimation device 100b according to embodiment 3, the density of the observation points 12 can be increased also in the filter at a long distance from the own vehicle 11, whereby the road wall shape can be estimated with high accuracy.

As described above, the observation data group accumulation unit 8 which accumulates data of observation points selected by the filter processing unit 3b is further provided, and the reference point calculation unit 4b calculates reference points from the output of the filter processing unit 3b and information of observation points accumulated in the observation data group accumulation unit 8. Thus, the density of the observation points 12 can be increased also in the filter at a long distance from the own vehicle 11, whereby the road wall shape can be estimated with high accuracy.

### Embodiment 4

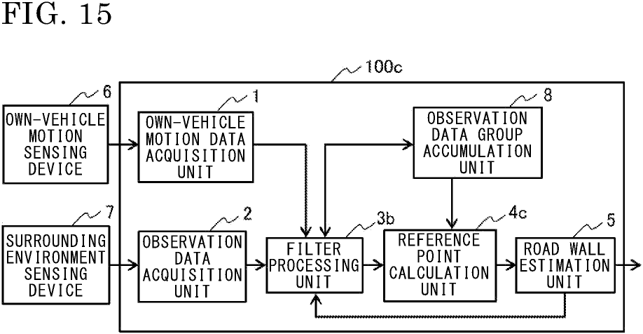

FIG. 15 shows the configuration of a road wall shape estimation device 100c according to embodiment 4. In the road wall shape estimation device 100c according to embodiment 4 shown in FIG. 15, a reference point calculation unit 4c is provided in place of the reference point calculation unit 4b as compared to the road wall shape estimation device 100b according to embodiment 3 shown in FIG. 11. The other configurations of the road wall shape estimation device 100c according to embodiment 4 are the same as those of the road wall shape estimation device 100b according to embodiment 3.

The reference point calculation unit 4c performs clustering processing for observation points including both of the observation points selected by the filter processing unit 3b and the observation points accumulated in the observation data group accumulation unit 8.

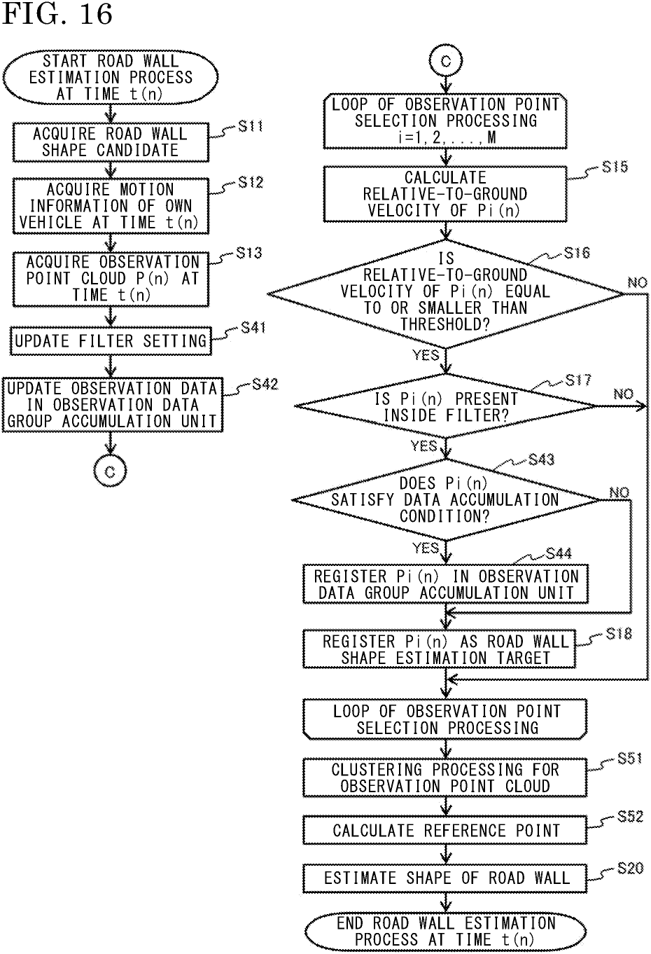

Next, with reference to a flowchart, operation of the road wall shape estimation device 100c will be described. FIG. 16 is a flowchart illustrating a process executed by the road wall shape estimation device 100c at an observation time t(n), and this process is repeatedly executed at constant time intervals, e.g., an observation update cycle of the surrounding environment sensing device 7. In FIG. 16, steps S11 to S18 and S20 are the same as those executed by the road wall shape estimation device 100b according to embodiment 3 shown in FIG. 12. Steps S51 and S52 are reference point calculation steps in embodiment 4.

### <Clustering Processing for Observation Points and Calculation of Reference Point>

In step S51, the reference point calculation unit 4c receives data of the observation points which are the output of the filter processing unit 3b and acquires data of the observation points from the observation data group accumulation unit 8. Then, for the observation points including both data, the reference point calculation unit 4c performs clustering processing, to calculate a reference point in each filter. As the clustering processing, for example, a known technique such as a DBSCAN algorithm may be used. In step S52, the position of a reference point is calculated using the observation points set as a cluster through the processing in step S51.

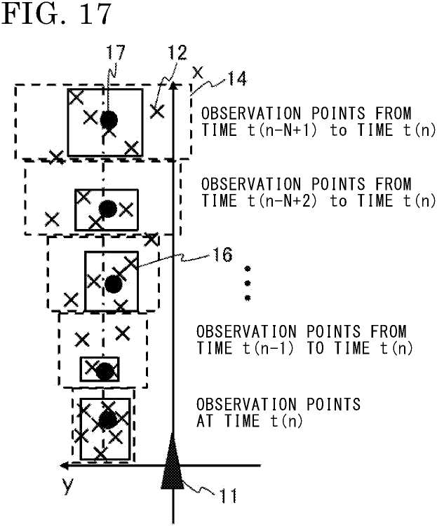

FIG. 17 illustrates operation of the reference point calculation unit 4c in embodiment 4. In the example shown in FIG. 17, only the observation points 12 at time (n) are included in the filter closest to the own vehicle 11, and the observation points 12 from time (n-N+1) to time (n) are included in the filter farthest from the own vehicle 11. Further, in the reference point calculation unit 4c, clustering processing is performed for these observation points 12 and thus clustering results 16 are obtained. The position of the reference point is any of an average position of the positions of observation points set as a cluster which are estimation target observation points, the position of the observation point closest to the own vehicle 11 among the observation points set as a cluster, or the most frequent position of the observation points set as a cluster. In FIG. 17, reference points 17 are shown by black circles.

As described above, the observation data group accumulation unit 8 which accumulates data of observation points selected by the filter processing unit 3b is further provided, and the reference point calculation unit 4c performs clustering processing of making a cluster from the observation points including both of the output of the filter processing unit 3b and the observation points accumulated in the observation data group accumulation unit 8, on the basis of similarities, and calculates a reference point from a result of the clustering processing. Thus, the density of the observation points 12 can be increased also in the filter at a long distance from the own vehicle 11, and data of low-reliability observation points away from the cluster can be removed, whereby the road wall shape can be estimated with high accuracy.

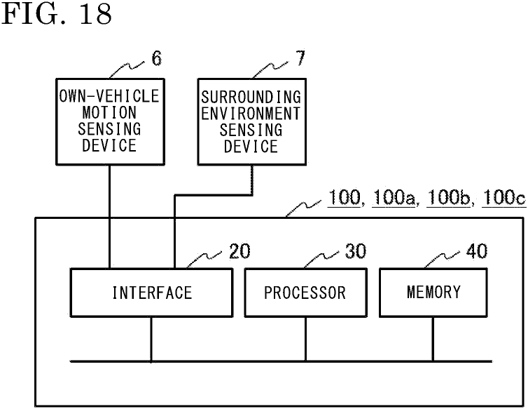

FIG. 18 is a schematic diagram showing an example of the hardware configuration of the road wall shape estimation device according to each of embodiments 1 to 4. The observation data group accumulation unit 8 is implemented by a memory 40. FIG. 18 shows a case where the own-vehicle motion data acquisition unit 1, the observation data acquisition unit 2, the filter processing unit 3, 3b, the reference point calculation unit 4, 4a, 4b, 4c, and the road wall estimation unit 5 are configured using a processor 30 such as a central processing unit (CPU) and a digital signal processor (DSP). A plurality of processing circuits may cooperate to execute the above functions. The function of each block is implemented by software, firmware, or a combination of software and firmware. The software or the firmware is described as a program and is stored in the memory 40. The processor 30 executes various processes in accordance with the program stored in the memory 40, to implement the function of each block. An interface 20 performs control for acquiring data from the own-vehicle motion sensing device 6 and the surrounding environment sensing device 7. The interface 20, the processor 30, and the memory 40 are connected to each other via buses.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

DESCRIPTION OF THE REFERENCE CHARACTERS

| | |
|---|---|
| 1 | own-vehicle motion data acquisition unit |
| 2 | observation data acquisition unit |
| 3, 3b | filter processing unit |
| 4, 4a, 4b, 4c | reference point calculation unit |
| 5 | road wall estimation unit |
| 6 | own-vehicle motion sensing device |
| 7 | surrounding environment sensing device |
| 8 | observation data group accumulation unit |
| 11 | own vehicle |
| 12 | observation point |
| 13 | road wall |
| 14 | filter |
| 15 | road wall candidate |
| 16 | clustering result |
| 17 | reference point |
| 20 | interface |
| 30 | processor |
| 40 | memory |
| 100,100a,100b,100c | road wall shape estimation device |

1. A road wall shape estimation device to estimate a shape of a road wall from information of an observation point cloud acquired by surrounding environment sensing device provided to an own vehicle, the road wall shape estimation device comprising:
an own-vehicle motion data acquisition circuitry to acquire motion information including a velocity of the own vehicle from own-vehicle motion sensing device;
an observation data acquisition circuitry to acquire the information of the observation point cloud from the surrounding environment sensing device;
a filter processing circuitry to set, in a virtual space where the observation point cloud is distributed, a plurality of rectangular filters in which a frontward direction of the own vehicle or an extending direction of a road wall candidate is a depth direction of each filter and a direction perpendicular to the depth direction is a width direction of each filter, such that the filters are arranged in the frontward direction of the own vehicle, and from the observation point cloud acquired by the observation data acquisition circuitry, outputs only observation points whose relative-to-ground velocities are equal to or smaller than a predetermined value and whose positions are inside the filters;
a reference point calculation circuitry to calculate a reference point in each filter from the output of the filter processing; and
a road wall estimation circuitry to estimate the shape of the road wall from the reference points, wherein
the filter processing circuitry increases a width of each filter as a position of the filter becomes farther from the own vehicle.

2. The road wall shape estimation device according to claim 1, wherein
the reference point calculation circuitry performs clustering processing of making a cluster from the observation points which are the output of the filter processing circuitry on the basis of similarities, and calculates the reference point from a result of the clustering processing.

3. The road wall shape estimation device according to claim 1, further comprising an observation data group accumulation circuitry to accumulate data of observation points selected by the filter processing circuitry, wherein
the reference point calculation circuitry calculates the reference point from the output of the filter processing circuitry and information of the observation points accumulated in the observation data group accumulation circuitry.

4. The road wall shape estimation device according to claim 1, further comprising an observation data group accumulation circuitry to accumulate data of observation points selected by the filter processing circuitry, wherein
the reference point calculation circuitry performs clustering processing of making a cluster from observation points including both of the output of the filter processing circuitry and the observation points accumulated in the observation data group accumulation circuitry, on the basis of similarities, and calculates the reference point from a result of the clustering processing.

5. A road wall shape estimation method to estimate a shape of a road wall from information of an observation point cloud acquired by surrounding environment sensing device provided to an own vehicle, the road wall shape estimation method comprising:
an own-vehicle motion data acquisition acquiring motion information including a velocity of the own vehicle from own-vehicle motion sensing device;
an observation data acquisition acquiring the information of the observation point cloud from the surrounding environment sensing device;
a filter update setting, in a virtual space where the observation point cloud is distributed, a plurality of rectangular filters in which a frontward direction of the own vehicle or an extending direction of a road wall candidate is a depth direction of each filter and a direction perpendicular to the depth direction is a width direction of each filter, such that the filters are arranged in the frontward direction of the own vehicle, so as to increase the width of each filter as a position of the filter becomes farther from the own vehicle;
a filter processing, from the observation point cloud acquired in the observation data acquisition, selecting only observation points whose relative-to-ground velocities are equal to or smaller than a predetermined value and whose positions are inside the filters;
a reference point calculation calculating a reference point in each filter from the observation points selected in the filter processing; and
a road wall estimation estimating the shape of the road wall from the reference points.

6. The road wall shape estimation method according to claim 5, wherein
in the reference point calculation, clustering processing of making a cluster from the observation points selected in the filter processing on the basis of similarities is performed, and the reference point is calculated from a result of the clustering processing.

7. The road wall shape estimation method according to claim 5, further comprising an observation point accumulation accumulating data of observation points selected in the filter processing-step, wherein
in the reference point calculation, the reference point is calculated from the observation points selected in the filter processing-step and the observation points accumulated in the observation point accumulation.

8. The road wall shape estimation method according to claim 5, further comprising an observation point accumulation accumulating data of observation points selected in the filter processing-step, wherein
in the reference point calculation-step, clustering processing of making a cluster from observation points including both of the observation points selected in the filter processing and the observation points accumulated in the observation point accumulation, on the basis of similarities, is performed, and the reference point is calculated from a result of the clustering processing.

9. The road wall shape estimation method according to claim 5, wherein
in the filter update-step, the plurality of filters are set adjacently to each other in the frontward direction of the own vehicle such that the frontward direction of the own vehicle is the depth direction of each filter and center positions in the width direction of the respective filters are aligned straightly in the frontward direction of the own vehicle.

10. The road wall shape estimation method according to claim 5, further comprising a road wall candidate acquisition acquiring information of the road wall candidate, wherein
in the filter update-step, the plurality of filters are set along the road wall candidate adjacently to each other in the frontward direction of the own vehicle such that the frontward direction of the own vehicle is the depth direction of each filter, and if reliability of the road wall candidate is lower than a predetermined value, a size of the filter is enlarged.

11. The road wall shape estimation method according to claim 5, further comprising a road wall candidate acquisition acquiring information of the road wall candidate, wherein
in the filter update-step, the plurality of rectangular filters are set along the road wall candidate such that the extending direction of the road wall candidate is the depth direction of each filter, and if reliability of the road wall candidate is lower than a predetermined value, a size of the filter is enlarged.

12. The road wall shape estimation method according to claim 10, wherein
the road wall candidate acquired in the road wall candidate acquisition-step is any of information of a road wall shape estimated at a past observation time, information acquired by second surrounding environment sensing device, or information acquired from map information.

13. The road wall shape estimation method according to claim 6, wherein
in the clustering processing, observation points present in a high-density area where the observation points are densely present so as to be close to each other are extracted as the cluster that is a clustering result, and an observation point away from the cluster is excluded as an outlier.

14. The road wall shape estimation method according to claim 7, wherein
in the filter update, a maximum accumulation period of observation point information is set for each filter such that the maximum accumulation period increases as the filter becomes farther from the own vehicle, and
the road wall shape estimation method further comprises an accumulated data update, among the observation points accumulated in the observation point accumulation step, deleting an observation point present outside each filter, and deleting an observation point which is present inside each filter and of which an accumulation period is greater than the maximum accumulation period set for the filter.

15. The road wall shape estimation method according to claim 5, wherein
in the reference point calculation, when the reference point is calculated from estimation target observation points, a position of the reference point is any of an average position of positions of the estimation target observation points, a position of the estimation target observation point closest to the own vehicle, or a most frequent position of the estimation target observation points.
